(19) United States
(12) Patent Application Publication
(10) Pub. No.: US 2006/0011356 A1
(43) Pub. Date: Jan. 19, 2006

(54) Fire-resistant tent for building structures

(76) Inventors: Gregory L. Temple, San Bernadino, CA (US); Marvin Wooten, North Las Vegas, NV (US)

Correspondence Address: ASHKAN NAJAFI, P.A., 6817 SOUTHPOINT PARKWAY, SUITE 2301, JACKSONVILLE, FL, 32216, US

(21) Appl. No.: 10/880,014

(22) Filed: Jun. 30, 2004

(51) Int. Cl. A62C 8/00

(52) U.S. Cl. 169/48; 169/49

(57) ABSTRACT

A device for protecting a combustible building from natural disasters includes a housing secured to a roof apex for containing flexible, fire-resistant liners movable between rolled and deployed positions. The present invention further includes a deploying mechanism including a shaft around which the liners are wound when maintained at a non-operating position and are unwound when deployed. The present invention further includes a fastening mechanism that has first and second sections secured to the bottom of the liners and extending from the building, respectfully. The first and second sections preferably include hooks to maintain the liners at a fixed position.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a fire-resistant tent and, more particularly, to a fire-resistant tent housed on a roof apex for protecting a structure made of combustible materials.

2. Prior Art

Currently, two methods are mostly often used in fire fighting of commercial building and residential house. One method is to use extinguishing chemicals to cover or coat burning materials; to cool the fire; or to inhibit the flame chain reactions. Most of these extinguishing chemicals, such as Halon chemicals and foam, are toxic and harmful to the human being. Halon chemicals have been identified to deplete ozone layer. Furthermore, these extinguishing chemicals are not effective for fighting large-area fire, because it is difficult to deliver a large amount of the extinguishing chemicals to the fire in a short period of time either by airplanes or ground vehicles. Also, to use a large amount of the extinguishing chemicals in fire fighting will cause the environment pollution.

Another method is to use water to suppress fire. This method is a traditional way and is widely used in the building and residential fire fighting. The major advantages of this method are no toxic and low cost. When fire is weak and small, i.e. temperature is low, water will be evaporated into steam, which cools the fire and blankets the fire by reducing the amount of air available. However, when fire is strong, i.e., the temperature is high, water will be resolved into hydrogen and oxygen, in which oxygen helps combustion.

There has long been a need for stabilizing and securing wood frame structures against fire damage. Wood, a natural cellulose material, is used in home construction in roofing, frames, support and plywood; however, wood has use restrictions in roofing as there is no approved commercial fire resistant treatment. If homes were not protected with nonflammable roofs, a fire could easily jump from house roof to house roof, especially with high winds.

Fire retardants are added or applied to cellulosic materials such as wood products to increase the resistance of that cellulosic material to fire. Such materials are less flammable than the cellulosic (wood) they protect. Some fire retardants prevent the spread of flame; others bun and thereby create a layer of char that inhibits further combustion. At the same time, some organic fire retardants may produce fairly toxic gases during exposure of the treated material to fire temperatures which may present problems for persons caught inside a burning building and for fire fighters.

Accordingly, a need remains for a fire-resistant tent for preventing fire damage to a building structure and for overcoming the above-noted shortcomings.

### BRIEF SUMMARY OF THE INVENTION

In view of the foregoing background, it is therefore an object of the present invention to provide a fire-resistant tent for building structures. These and other objects, features, and advantages of the invention are provided by a device for protecting a combustible building structure from natural disasters, which includes an elongated housing secured at an apex of a roof structure. Such a housing has a predetermined length and a centrally disposed longitudinal axis extending along the apex.

Advantageously, the present invention further includes a plurality of flexible liners disposed within the housing and movable between rolled and deployed positions for traveling downwardly along a roof and sidewalls of a building structure. Such a plurality of liners are adaptable for covering and protecting the building structure from the environment while depleting an oxygen level therebeneath. The plurality of liners are formed from fire-resistant material that may include Nomex, for example, or other suitable fire-resistant materials well-known in the industry.

The present invention further includes a mechanism for deploying the plurality of liners from the apex wherein the deploying mechanism is contained within the housing. Such a deploying mechanism includes a plurality of brackets spaced apart at a predetermined distance. A central shaft with opposed end portions is journaled between the plurality of brackets. The plurality of liners are wrapped about the shaft when maintained at a non-operating position and are unwound outwardly from the housing when deployed to an operating position.

The present invention further includes a mechanism for removably fastening the plurality of liners adjacent a perimeter of a building structure during operating conditions. Such a fastening mechanism has a first section secured to a bottom portion of the plurality of liners and further has a second section extending outwardly from the building structure for receiving and cooperating with the first section and effectively maintaining the plurality of liners at a substantially stable position.

The first section preferably includes a plurality of hooks randomly spaced apart and extending along a first plane. Furthermore, the second section includes a plurality hooks aligned with the first section plurality of hooks and extends along a second plane to thereby maintain the plurality of liners at a substantially fixed position.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a front elevational view showing a fire-resistant tent housed along a roof apex of a building structure, in accordance with the present invention;

FIG. 2 is a side elevational view taken along line 2-2 and showing the present invention at a deployed state;

FIG. 3 is an enlarged partial break-away view of the present invention shown in FIG. 2, taken along line 3-3;

FIG. 4 is an enlarged partial break-away view of the present invention shown in FIG. 2; and

FIG. 5 is an enlarged cross-sectional view of the deploying mechanism shown in FIG. 3.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

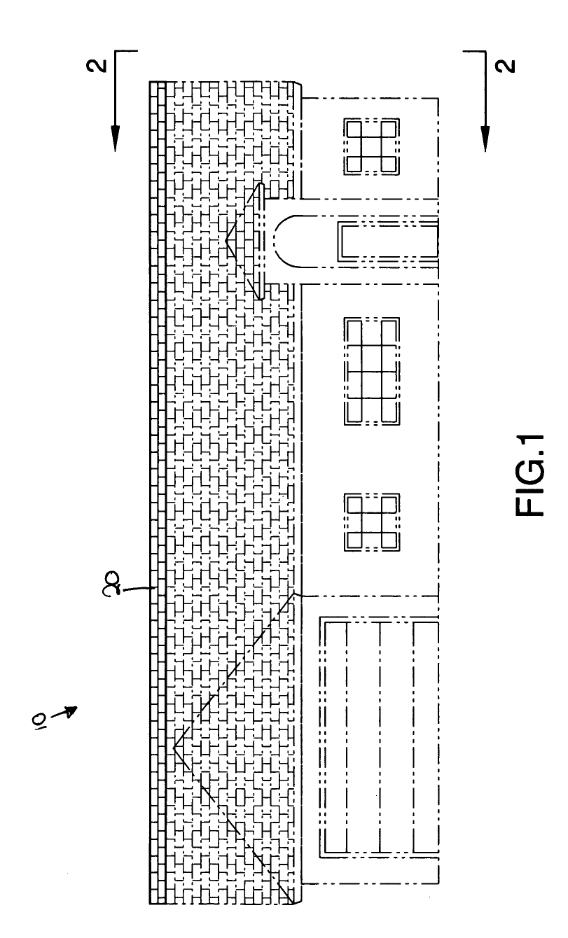

The device of this invention is referred to generally in FIGS. 1-5 by the reference numeral 10 and is intended to protect a building structure from fire. It should be understood that the device 10 may be used to protect structures of many different sizes and designs.

Referring initially to FIG. 1, the device 10 includes an elongated housing 20 secured at an apex of a roof structure. Such a housing 20 has a predetermined length and a centrally disposed longitudinal axis extending along the apex.

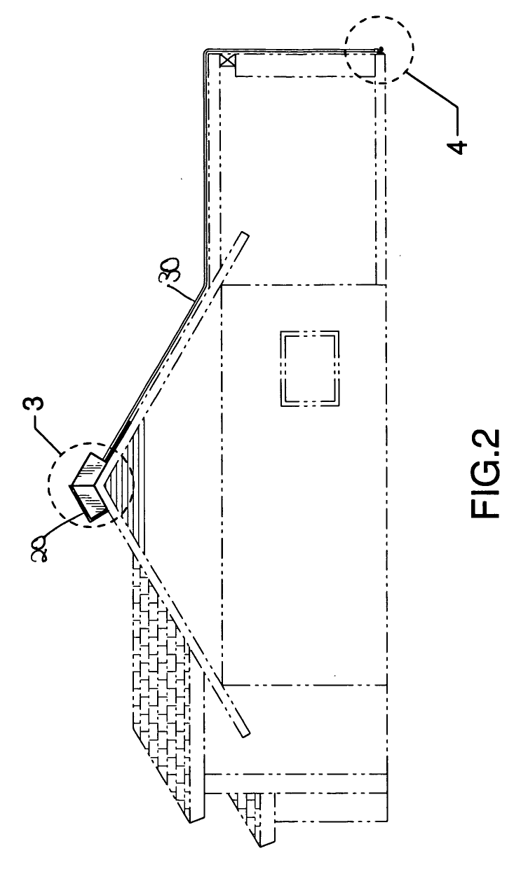

Now referring to FIG. 2, the present invention advantageously includes a plurality of flexible liners 30 disposed within the housing 20 and movable between rolled and deployed positions for traveling downwardly along a roof and sidewalls of a building structure. Such a plurality of liners 30 are adaptable for covering and protecting the building structure from the environment while depleting an oxygen level therebeneath. By depleting the oxygen from beneath the plurality of liners 30, the present invention prevents fire from propagating and engulfing a building. The plurality of liners 30 are formed from fire-resistant material that may include Nomex, for example, or other suitable fire-resistant materials well-known in the industry.

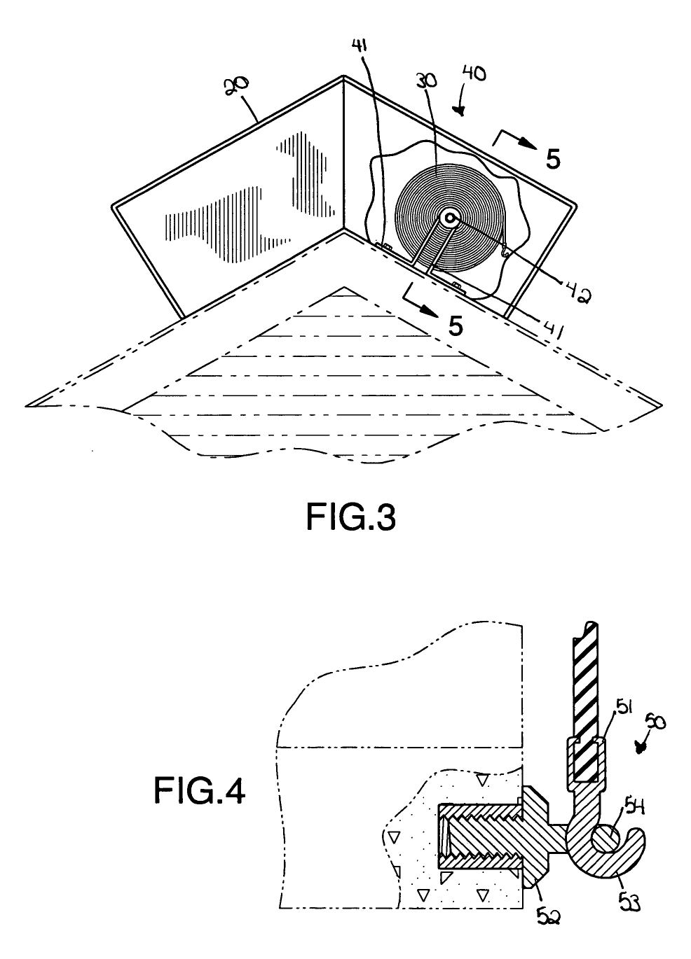

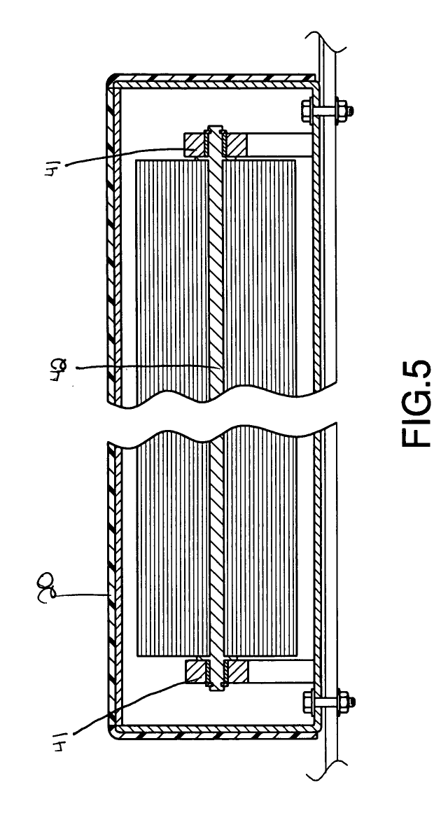

Referring to FIGS. 3 and 5, the present invention further includes a mechanism 40 for deploying the plurality of liners 30 from the apex wherein the deploying mechanism 40 is contained within the housing 20. Such a deploying mechanism 40 includes a plurality of brackets 41 spaced apart at a predetermined distance. A central shaft 42 with opposed end portions is journaled between the plurality of brackets 41. The plurality of liners 30 are wrapped about the shaft 42 when maintained at a non-operating position and are unwound outwardly from the housing 20 when deployed to an operating position. Advantageously, the plurality of liners 30 are permanently affixed to a roof top and the mechanism 40 allows for efficient deployment of the present invention in the case of an emergency, such as a quickly spreading wildfire.

Referring to FIG. 4, the present invention further includes a mechanism 50 for removably fastening the plurality of liners 30 adjacent a perimeter of a building structure during operating conditions. Such a fastening mechanism 50 has a first section 51 secured to a bottom portion of the plurality of liners 30 and further has a second section 52 extending outwardly from the building structure for receiving and cooperating with the first section 51 and effectively maintaining the plurality of liners 30 at a substantially stable position.

The first section 51 preferably includes a plurality of hooks 53 randomly spaced apart and extending along a first plane. Similarly, the second section 52 includes a plurality hooks 54 aligned with the first section plurality of hooks 53 and extends along a second plane to thereby maintain the plurality of liners 30 at a substantially fixed position. Often, substantial winds accompany a large wildfire, which causes certain objects to become unstable. To overcome this shortcoming, the fastening mechanism 50 secures the plurality of liners 30 to a building and maximizes the protection of a structure in the presence of large winds.

The appealing features of the present invention are its ease of use and the safety and protection it could provide and therefore is an effective tool in preventing significant property damage during the event of a fire.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A device for protecting a combustible building structure from natural disasters, said device comprising:
an elongated housing secured at an apex of a roof structure, said housing having a predetermined length and a centrally disposed longitudinal axis extending along the apex;
a plurality of flexible liners disposed within said housing and being movable between rolled and deployed positions for traveling downwardly along a roof and sidewalls of a building structure, said plurality of liners for adaptable for covering and protecting the building structure from the environment while depleting an oxygen level therebeneath;
means for deploying said plurality of liners from the apex wherein said deploying means is contained within said housing; and
means for removably fastening said plurality of liners adjacent a perimeter of a building structure during operating conditions, said fastening means having a first section secured to a bottom portion of said plurality of liners and further having a second section extending outwardly from the building structure for receiving and cooperating with said first section and effectively maintaining said plurality of liners at a substantially stable position.

2. The device of claim 1, wherein said plurality of liners are formed from fire-resistant material comprising Nomex.

3. The device of claim 1, wherein said first section comprises a plurality of hooks randomly spaced apart and extending along a first plane; and
said second section comprising a plurality hooks aligned with said first section plurality of hooks and extending along a second plane to thereby maintain said plurality of liners at a substantially fixed position.

4. The device of claim 1, wherein said deploying means comprises:
a plurality of brackets spaced apart at a predetermined distance; and
a central shaft having opposed end portions journaled between said plurality of brackets, said plurality of liners being wrapped about said shaft when maintained at a non-operating position and being unwound outwardly from the housing when being deployed to an operating position.

5. A device for protecting a combustible building structure from natural disasters, said device comprising:
an elongated housing secured at an apex of a roof structure, said housing having a predetermined length and a centrally disposed longitudinal axis extending along the apex;
a plurality of flexible fire-resistant liners disposed within said housing and being movable between rolled and deployed positions for traveling downwardly along a roof and sidewalls of a building structure, said plurality of liners for adaptable for covering and protecting the building structure from the environment while depleting an oxygen level therebeneath;
means for deploying said plurality of liners from the apex wherein said deploying means is contained within said housing; and
means for removably fastening said plurality of liners adjacent a perimeter of a building structure during operating conditions, said fastening means having a first section secured to a bottom portion of said plurality of liners and further having a second section extending outwardly from the building structure for receiving and cooperating with said first section and effectively maintaining said plurality of liners at a substantially stable position.

6. The device of claim 5, wherein said plurality of liners are formed from Nomex.

7. The device of claim 5, wherein said first section comprises a plurality of hooks randomly spaced apart and extending along a first plane; and
said second section comprising a plurality hooks aligned with said first section plurality of hooks and extending along a second plane to thereby maintain said plurality of liners at a substantially fixed position.

8. The device of claim 5, wherein said deploying means comprises:
a plurality of brackets spaced apart at a predetermined distance; and
a central shaft having opposed end portions journaled between said plurality of brackets, said plurality of liners being wrapped about said shaft when maintained at a non-operating position and being unwound outwardly from the housing when being deployed to an operating position.

9. A device for protecting a combustible building structure from natural disasters, said device comprising:
an elongated housing secured at an apex of a roof structure, said housing having a predetermined length and a centrally disposed longitudinal axis extending along the apex;
a plurality of flexible fire-resistant liners disposed within said housing and being movable between rolled and deployed positions for traveling downwardly along a roof and sidewalls of a building structure, said plurality of liners for adaptable for covering and protecting the building structure from the environment while depleting an oxygen level therebeneath;
means for deploying said plurality of liners from the apex wherein said deploying means is contained within said housing; and
means for removably fastening said plurality of liners adjacent a perimeter of a building structure during operating conditions, said fastening means having a first section secured to a bottom portion of said plurality of liners and further having a second section extending outwardly from the building structure for receiving and cooperating with said first section and effectively maintaining said plurality of liners at a substantially stable position, said first section comprising a plurality of hooks randomly spaced apart and extending along a first plane, said second section comprising a plurality hooks aligned with said first section plurality of hooks and extending along a second plane to thereby maintain said plurality of liners at a substantially fixed position.

10. The device of claim 9, wherein said plurality of liners are formed from Nomex.

11. The device of claim 9, wherein said deploying means comprises:
a plurality of brackets spaced apart at a predetermined distance; and
a central shaft having opposed end portions journaled between said plurality of brackets, said plurality of liners being wrapped about said shaft when maintained at a non-operating position and being unwound outwardly from the housing when being deployed to an operating position.
